(19) United States
(12) Patent Application Publication
(10) Pub. No.: US 2019/0290061 A1
(43) Pub. Date: Sep. 26, 2019

(54) Cooking Utensil

(71) Applicants: Victor Diaz de León, Miami, FL (US); Gerardo Hernández, Hialeah, FL (US)

(72) Inventors: Victor Diaz de León, Miami, FL (US); Gerardo Hernández, Hialeah, FL (US)

(21) Appl. No.: 16/201,458

(22) Filed: Nov. 27, 2018

Related U.S. Application Data
(60) Provisional application No. 62/707,978, filed on Nov. 28, 2017.

(51) Int. Cl. A47J 37/04

(52) U.S. Cl. CPC A47J 37/041

(57) ABSTRACT

A new and versatile cooking utensil designed for making Tacos al Pastor, and other meats, at home. The cooking utensil has a chrome coated steel base on which slices of pork and pineapple, or other food ingredients, can be layered onto a removable skewer. From the base of the cooking utensil protrudes a handle providing ease of maneuverability and transportation of the ingredients. The utensil and ingredients may be placed in any standard sized oven, or grill, for cooking.

### PRIORITY

This application claims priority to U.S. Provisional Patent Application Ser. No. 62/707,978, filed on Nov. 28, 2017, which is incorporated by reference in its entirety.

### FIELD OF INVENTION

The exemplary embodiments provide a portable, easy-to-use, and affordable cooking utensil that can be used to cook Tacos al Pastor, or other meats.

### BACKGROUND

Tacos al Pastor is dish from Central Mexico, based on spit-grilled meat that was brought to the country by Lebanese immigrants. There is some variety in the recipe of Tacos al Pastor, but the basic idea includes cooking thin slices of layered pork and pineapple that have been marinated in chilies and spices. The slices of meat and pineapple are layered onto a rotating skewer and cooked on a vertical broiler. Once the layered ingredients have thoroughly cooked, small pieces are shaved off with a sharp knife, and then put into a maize/flour tortilla.

Vertical broilers that enable one to layer ingredients on a rotating skewer are very expensive. Furthermore, vertical broilers require a large amount of space dedicated to the broiler. The cost and space requirements become prohibitive for the common person to own such broilers. Thus, vertical broilers are limited to the commercial market.

Alternative methods of making Tacos al Pastor at home without buying an expensive vertical broiler are limited to slow-cooking the pork and pineapple in a loaf pan before re-crisping it in a skillet. This is a two-part process that is both laborious and time consuming. Also, it does not result in the same experience of personally shaving off the meat from the skewer straight into a taco.

Another method includes layering the meat and pineapple onto a wooden skewer, commonly used for Shish Kebabs. When tried, this method does not truly provide a stable base for the stack of ingredients and can be extremely difficult to move from a baking pan to a presentable serving dish. Furthermore, as the ingredients are not elevated, the fats and oils from the ingredients are not able to properly drain off, thus the bottom ingredients sit in them and do not cook properly.

There exists a need to have a utensil which both reduces the cost and space associated with making Tacos al Pastor and other meats.

The following disclosure and attached drawings describe examples of some embodiments of the invention. The designs, figures, and description are non-limiting examples. Other embodiments of the cooking utensil may or may not include the features disclosed herein.

### SUMMARY

The exemplary embodiments provide a cooking utensil that enables anyone to make Tacos al Pastor in the comfort of their own home. The exemplary embodiments can also provide restaurants with the ability to serve personalized Tacos al Pastor where customers can shave off their own taco meat in an interactive presentation. The cooking utensil provides a base on which slices of pork and pineapple can be layered onto a removable skewer. A handle protruding from the base provides ease of maneuverability of the ingredients. The utensil and ingredients can then be cooked within any standard sized oven.

In certain exemplary embodiments, the invention is a cooking utensil comprising: a base having a generally round shape, a top surface, and a bottom surface, the base further comprising a center round hole; supporting legs coupled to the base such that the base is elevated with respect to a bottom of the supporting legs; a skewer coupled to the center round hole of the steel base; and a handle coupled to the steel base. In certain exemplary embodiments, the supporting legs that are welded to the steel base. In certain exemplary embodiments, the skewer comprises a pointed tip at one end. In certain exemplary embodiments, the handle is welded to the base. In certain exemplary embodiments, the handle is U-shaped. In certain exemplary embodiments, the supporting legs, the handle and the skewer comprise chrome coated steel. In certain exemplary embodiments, the base comprises steel. In certain exemplary embodiments, the cooking utensil of claim 6, wherein the cooking utensil is configured to fit in a conventional cooking oven.

In certain exemplary embodiments, the invention is a method of cooking meat using a cooking utensil comprising: a base having a generally round shape, a top surface, and a bottom surface, the base further comprising a center round hole; supporting legs coupled to the base such that the base is elevated with respect to a bottom of the supporting legs; a skewer coupled to the center round hole of the steel base; and a handle coupled to the steel base. In certain embodiments, the supporting legs are welded to the steel base. In certain embodiments, the skewer comprises a pointed tip at one end. In certain embodiments, the handle is welded to the base. In certain embodiments, the handle is U-shaped. In certain embodiments, the handle and the skewer comprise chrome coated steel. In certain embodiments, the base comprises steel. In certain embodiments, the cooking utensil is configured to fit in a conventional cooking oven.

### BRIEF DESCRIPTION OF THE DRAWINGS

While the attached drawings show, describe and point out novel features as applied to various embodiments, it will be understood that various omissions, substitutions, and changes in the form and details of the utensil may be made without departing from the spirit of the disclosure. As will be recognized, certain embodiments described herein may be embodied within a form that does not provide all of the features and benefits set forth herein, as some features may be used or practiced separately from others.

FIG. 1 shows a perspective view of a fully assembled cooking utensil according to various exemplary embodiments.

FIG. 2 shows a front view of a fully assembled cooking utensil according to various exemplary embodiments.

FIG. 3a shows a side view of a fully assembled cooking utensil according to various exemplary embodiments. FIG. 3b shows a side view of a fully assembled cooking utensil according to various exemplary embodiments further showing ingredients stacked onto the utensil.

FIG. 4 shows a bottom view of a fully assembled cooking utensil according to various exemplary embodiments.

FIG. 5 shows a top view of a fully assembled cooking utensil according to various exemplary embodiments.

FIG. 6 shows a side view of a fully assembled cooking utensil according to various exemplary embodiments. The threaded removable skewer (40) is shown both placed into the circular base (10) and isolated.

### DETAILED DESCRIPTION

The particulars shown herein are by way of example and for purposes of illustrative discussion of the invention only and are presented to provide what is believed to be the most useful and readily understood description of the principles and conceptual aspects of the invention. It will nevertheless be understood that of the scope of the invention disclosure includes equivalents not particularized herein but nonetheless enabled by the instant specification or would be known to skilled artisans.

The exemplary embodiments provide a portable, easy-to-use, and affordable cooking utensil that can be used to cook Tacos al Pastor or other meats. The exemplary embodiments provide a domestic alternative to current methods for cooking Tacos al Pastor and other meats and can conveniently be used safely within any standard sized oven. Furthermore, embodiments of this invention may be used in restaurants to serve customers personalized Tacos al Pastor. The cooking utensil can be cooked with layers sufficient for 1-8 people and can easily be an interactive dish for Mexican food enthusiasts to enjoy. In certain embodiments, restaurants of any cuisine can use the utensil to cook any combination of ingredients to serve customers personalized interactive meals.

The exemplary embodiments include a cooking utensil and methods for using the cooking utensil for cooking Tacos Al Pastor and other meat dishes.

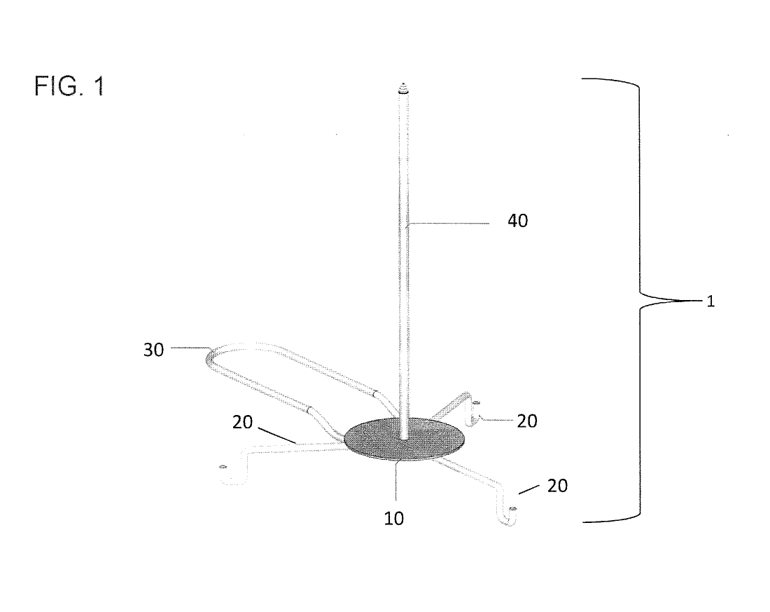

FIG. 1 shows a perspective view of a fully assembled cooking utensil according to various exemplary embodiments. The cooking utensil (1) includes a circular base (10) from which three stabilizing legs (20) extend. In certain embodiments, the base (10) is made of metal. For example, in certain embodiments, the base (10) is made of steel. The base (10) may be any shape that may hold the ingredients. The base (10) may be circular, polygonal, square or hexagonal.

The stabilizing legs (20) may be constructed from chrome plated steel. For example, the stabilizing legs (20) may be constructed from 100% steel and chrome plated for better protection and durability.

A handle (30) extends from the circular base (10) with a slight upward angle to give room to grab the handle (30). The handle (30) may be constructed from chrome plated stainless steel in the same manner as the stabilizing legs (20). In this exemplary embodiment, the handle (30) is U-shaped. However, the handle (30) may take on other shapes.

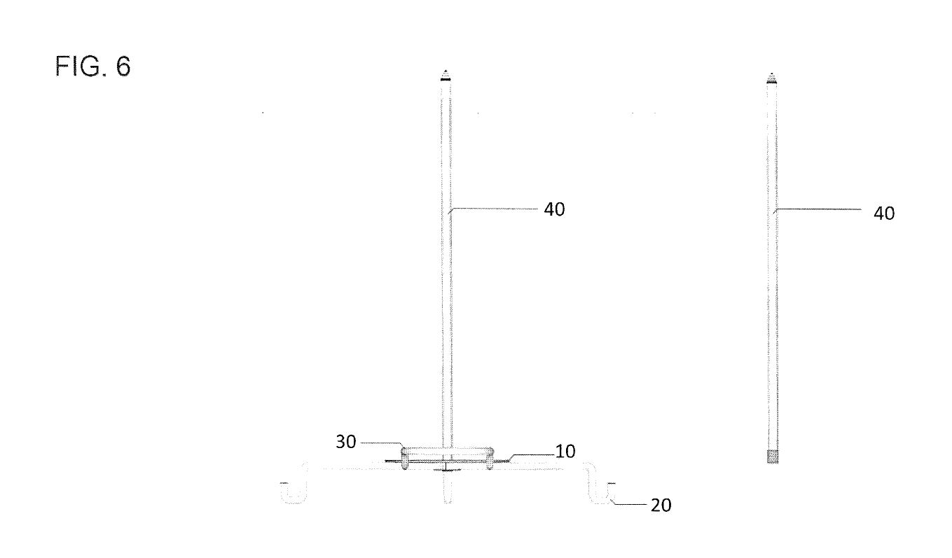

The removable skewer (40) may be screwed into the center of the base (10). An exemplary manner of attaching the removable skewer (40) to the base (10) will be described in greater detail below with reference to FIG. 6. The skewer (40) may be constructed from chrome plated stainless steel in the same manner as the stabilizing legs (20). While the exemplary embodiments of the stabilizing legs (20), the handle (30) and the skewer (40) have been described as being constructed from chrome plated stainless steel, any other oven safe and food safe material may be used to construct these components of the cooking utensil (1).

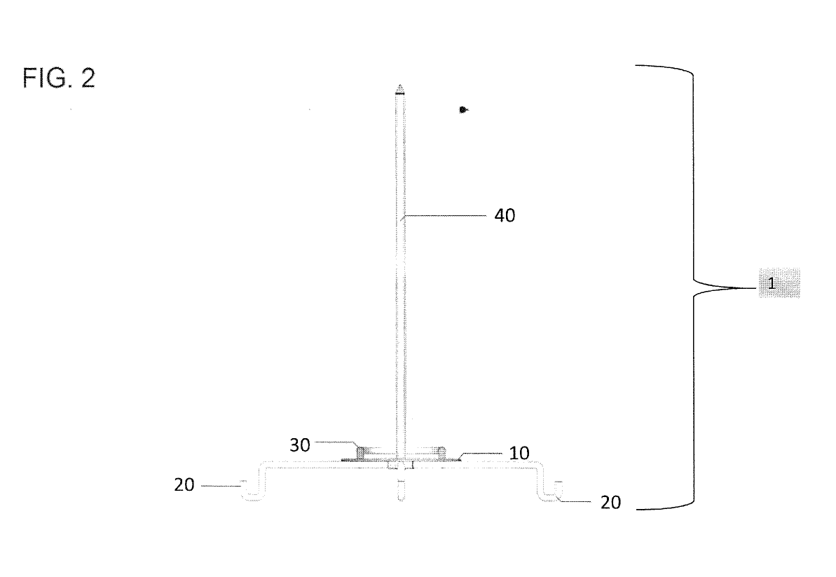

FIG. 2 shows a front view of a fully assembled cooking utensil (1) according to various exemplary embodiments. This view shows that the base (10) is raised with respect to the bottom of the stabilizing legs (20). Thus, the cooking utensil (1) when placed in an oven may be placed on a baking sheet or other flat surface that may catch the fat and other juices that drip from the ingredients (50). For example, because the base (10) is raised, fat juices from the ingredients (50) may flow away from the meat.

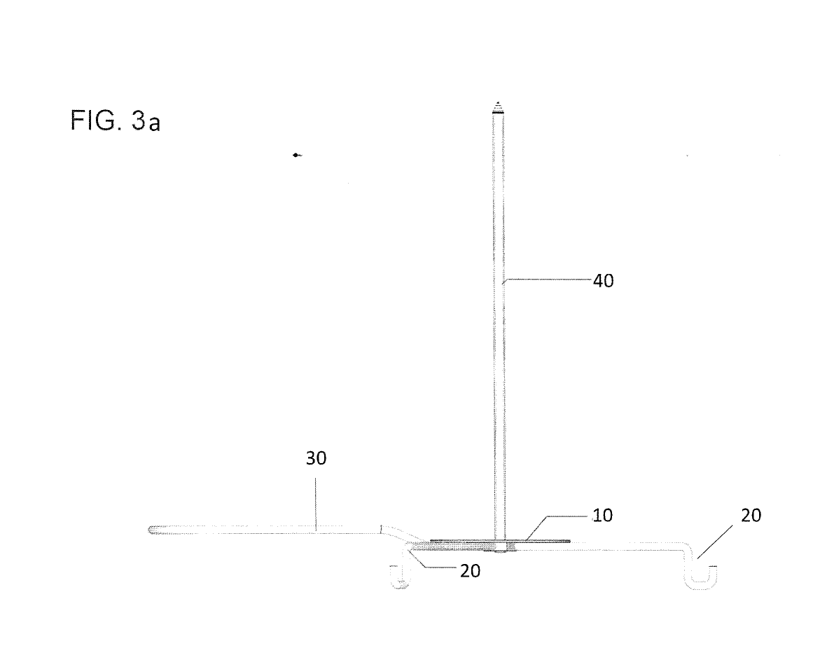

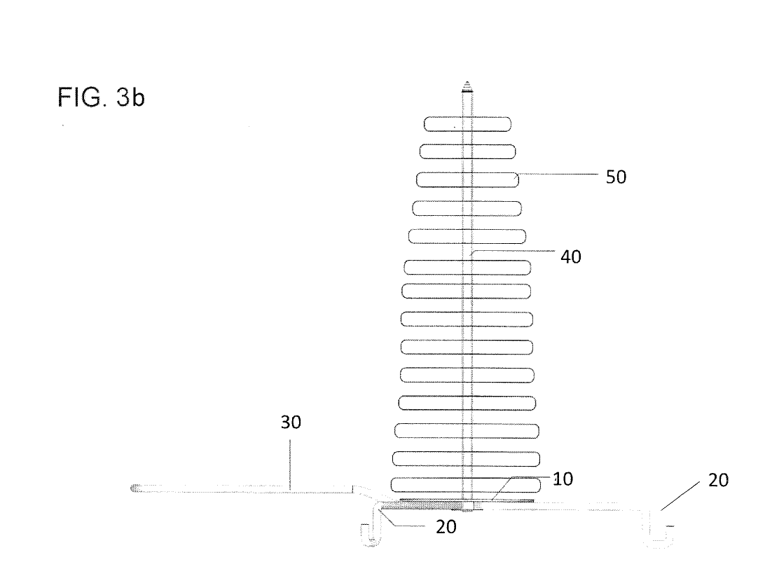

FIG. 3a shows a side view of a fully assembled cooking utensil (1) according to various exemplary embodiments. The skewer (40) may be attached to the circular base (10). As described above, the legs (20) raise the base (10). The handle (30) may extend at an angle from the circular base (10) causing the main portion of the handle to be elevated from the base (10). This elevation of the handle (30) with respect to the base (10) may allow a user to have better control when lifting the cooking utensil (1) when fully loaded because the handle (30) will be closer to the center of gravity of the fully loaded cooking utensil (1). Thus, it should be understood that the handle (30) may be raised higher with respect to the center of gravity of a fully loaded cooking utensil (1). Moreover, the raised handle (30) may allow a user to wrap their hand around the handle (30) without touching an oven rack or other component of the cooking utensil (1) or the oven in which it is placed.

FIG. 3b shows a side view of a fully assembled cooking utensil according to various exemplary embodiments further showing ingredients stacked onto the utensil. Ingredients (50) are placed around the skewer (40) and with the bottom portion of the ingredients (50) resting on the circular base (10). The remaining ingredients (50) are stacked on the skewer (40).

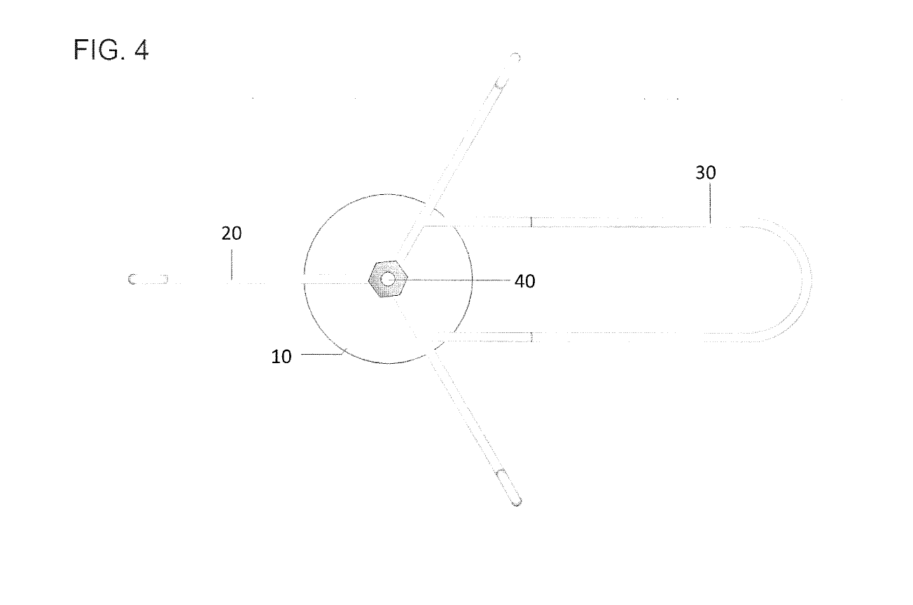

FIG. 4 shows a bottom view of a fully assembled cooking utensil (1) according to various exemplary embodiments. This perspective shows the construction of the circular base (10), legs (20), and handle (30). The circular base (10), legs (20), and handle (30) may be connected by welding each piece together. This embodiment provides for a cooking utensil (1) that will not easily break. In certain embodiments, the connection means may be a screw.

In exemplary embodiments, the skewer (40) may be connected to the base (10) by a connection means. For the exemplary embodiment depicted in FIG. 4, the center of the circular base (10) is a threaded hole so that the removable skewer (40) can easily be screwed into or out of the utensil.

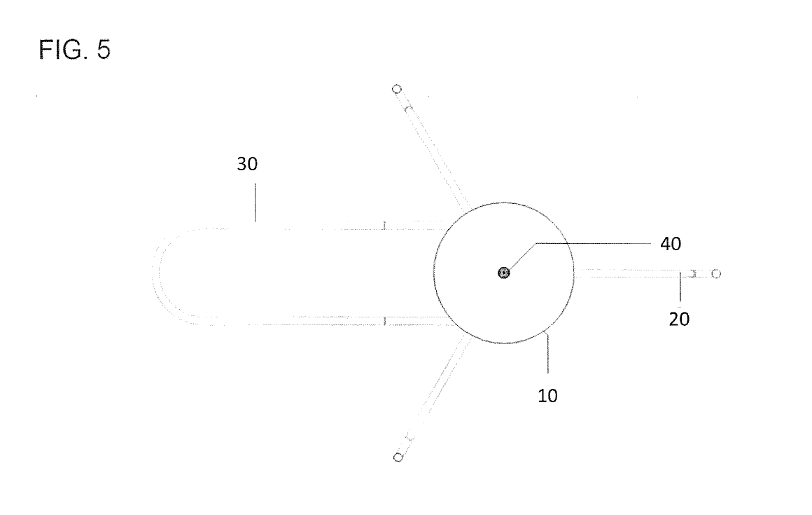

FIG. 5 shows a top view of a fully assembled cooking utensil (1) according to various exemplary embodiments. The circular base (10), legs (20), handle (30) and the removable skewer (40) can be seen.

FIG. 6 shows a side view of a fully assembled cooking utensil according to various exemplary embodiments. The threaded removable skewer (40) is shown both placed into the circular base (10) and isolated.

In certain embodiments, the utensil comprises a removable metal skewer, a “U” shaped handle, a round base, and three legs to stack up the meat and other ingredients.

Metal coating of the cooking utensil may allow for more durability, and its three stabilizing legs allow for the meat to be evenly cooked, and comfortably cut once taken out of the oven. However, any number of legs (20) may be used depending on the use of the cooking utensil (1). The handle (30) allows for easy transporting of the cooking utensil (1) without touching the ingredients, while the raised base (10) serves as a drain for all the fats and liquids released by the ingredients.

In certain embodiments, the utensil (1) may be supplied in two parts that can be left together or taken apart for more convenient storage. In certain embodiments, the base (10) contains three extending legs (20) that stabilize the structure and can be placed on any flat surface. In such embodiments, the legs (20) raise the base (10) up so that fat and oils can drain off from the cooking ingredients appropriately.

In certain embodiments, a handle (30) extends from the base (10) that allows one to easily pick up the utensil (1) without disturbing the layered ingredients and transport it from a baking pan within the oven to a presentable dish for serving.

In certain embodiments, the removable skewer (40) screws into the base (10) and has a pointed tip allowing easy puncture into ingredients. In certain embodiments, the point is rounded to help prevent against self-puncture or any other self-inflicted injuries. In certain embodiments, when the skewer (40) is screwed into the flat base (10) and set in a baking pan, both the utensil and baking pan fit comfortably within any standard sized oven.

The following provides an exemplary use of the cooking utensil (1). A user may place the cooking utensil (1) on a flat surface such as a cooking counter. The user may then stack the ingredients (50) onto the skewer (40) as shown in the various figures above. The user may then place the fully loaded cooking utensil (1) into a pre-heated the cooking oven. As described above the cooking utensil (1) is sized such that it will fit into a standard sized cooking oven. As also described above, the cooking utensil (1) may be placed directly on a baking sheet or other pan to catch the juices during cooking or the baking sheet may be placed on an oven rack below the cooking utensil (1). The ingredients (50) may then cook in the oven. Those skilled in the art will understand that because the vertical broiler is not being used, the ingredients (50) will cook in a different manner, e.g., the ingredients will be roasted, rather than broiled. When the ingredients are finished cooking, the user may easily remove the cooking utensil (1) from the oven using the handle (30). The cooking utensil (1) may then again be placed on a flat surface such as a cooking table, where diners may cut or shave the ingredients (50) from the cooking utensil (1) to make tacos al pastor.

The cooking utensil (1) is not limited to cooking specifically Tacos al Pastor. One can use the cooking utensil (1) to cook any desired meat ingredient and flavor it with any desired marinades, herbs, seasonings, and spices. One of skill in the art would appreciate that any beef, chicken, lamb, pork, or fish may be used as such a meat ingredient. In certain embodiments, the meat ingredient is selected from gyro, pork, beef and lamb.

The foregoing description has been presented only for purposes of illustration and description. This description is not intended to limit the invention to the precise form disclosed. It is intended that the scope of the invention be defined by the claims appended hereto.

1. A cooking utensil comprising:
a base having a generally round shape, a top surface, and a bottom surface, the base further comprising a center round hole;
supporting legs coupled to the base such that the base is elevated with respect to a bottom of the supporting legs;
a skewer coupled to the center round hole of the steel base; and
a handle coupled to the steel base.

2. The cooking utensil of claim 1, wherein the supporting legs are welded to the steel base.

3. The cooking utensil of claim 1, wherein the skewer comprises a pointed tip at one end.

4. The cooking utensil of claim 1, wherein the handle is welded to the base.

5. The cooking utensil of claim 1, wherein the handle is U-shaped.

6. The cooking utensil of claim 1, wherein the supporting legs, the handle and the skewer comprise chrome coated steel.

7. The cooking utensil of claim 1, wherein the base comprises steel.

8. The cooking utensil of claim 6, wherein the cooking utensil is configured to fit in a conventional cooking oven.

9. A method of cooking meat using a cooking utensil comprising:
a base having a generally round shape, a top surface, and a bottom surface, the base further comprising a center round hole;
supporting legs coupled to the base such that the base is elevated with respect to a bottom of the supporting legs;
a skewer coupled to the center round hole of the steel base; and
a handle coupled to the steel base.

10. The method of claim 9, wherein the supporting legs are welded to the steel base.

11. The method of claim 9, wherein the skewer comprises a pointed tip at one end.

12. The method of claim 9, wherein the handle is welded to the base.

13. The method of claim 9, wherein the handle is U-shaped.

14. The method of claim 9, wherein the supporting legs, the handle and the skewer comprise chrome coated steel.

15. The method of claim 9, wherein the base comprises steel.

16. The method of claim 14, wherein the cooking utensil is configured to fit in a conventional cooking oven.
